(19) United States
(12) Patent Application Publication
(10) Pub. No.: US 2013/0046626 A1
(43) Pub. Date: Feb. 21, 2013

(54) OPTIMIZING OFFERS BASED ON USER TRANSACTION HISTORY

(71) Applicants: David M. Grigg, Rock Hill, SC (US); Matthew A. Calman, Charlotte, NC (US); Erik Stephen Ross, Charlotte, NC (US); Raja Bose, Charlotte, NC (US)

(72) Inventors: David M. Grigg, Rock Hill, SC (US); Matthew A. Calman, Charlotte, NC (US); Erik Stephen Ross, Charlotte, NC (US); Raja Bose, Charlotte, NC (US)

(73) Assignee: BANK OF AMERICA CORPORATION, Charlotte, NC (US)

(21) Appl. No.: 13/213,935

(22) Filed: Aug. 19, 2011

(51) Int. Cl. G06Q 30/00

(52) U.S. Cl. 705/14.53

(57) ABSTRACT

Embodiments of the invention are directed to a system, method, or computer program product for providing offers to purchase products or services to a user, the offers being tailored to the user. Embodiments of the invention allow a user to receive offers to purchase products based on the user's transaction history, offer acceptance history, demographic, or offers for products that the user wishes. In this way, the user receives offers for products that he/she may be interested in instead of having to find offers he/she is interested in by searching all the offers available to him/her. A financial institution may receive information regarding the user's transaction history, offer acceptance history, demographic, or watch list. This information may provide parameters for a filter to which offers may be provided to the user, such that the offers that are provided to the user may be of interest to him/her. Thus, the system may optimize the offers provided to the user to ensure that the offers the user receives are ones that he/she may have an interest in using to purchase a product or service.

### BACKGROUND

Many factors may play a role in an individual's selection of a particular product. The individual's perception of the brand, past use of a product, past use of a brand, advertisement of a product, advertisement of a brand, offers for discounts for a product, etc., may all have a direct correlation with which products an individual may select to purchase. Not only does the brand of product play a role in product purchasing, the type of merchant may have a role in an individual purchasing a product as well. The individual's perception of the merchant, merchant discounts, merchant advertisement, convenience of a merchant's store, etc. may also has a direct correlation with products an individual may select to purchase.

Offers for a product may include discounts, promotions, coupons, and/or the like. These offers may be found at a store, in a newspaper, online, on television, in an advertisement, or many other places. Typically, individuals will use the offers that are designated to products that they would purchase based on the above listed factors. The offer may not be the deciding factor when it comes to purchasing a product. The individual may only use offers for products that the individual was already considering purchasing or will purchase due to how beneficial the offer is to the individual. In any way, the offers that an individual may use are few in comparison to the amount of offers the individual may receive. For example, an individual may receive promotions, coupons, and the like in a newspaper. Individuals will cut out the coupons they are interested in and discard the remaining coupons. There will only be a few coupons the individual may cut out of the newspaper and save, the majority of coupons will be disposed of by the individual.

The offers found at a store, in a newspaper, online, on television, in an advertisement, or other places may be directed to the public as a whole. In this way, the offers show products that the merchant has and is able to sell to individuals at a discounted price. However, these offers may not reach all of the individuals interested in the offer and may, instead, reach many individuals not interested in the offers.

Therefore, a need exists for individuals to receive offers for products that they may be interested in purchasing the product.

### BRIEF SUMMARY

Embodiments of the present invention address the above needs and/or achieve other advantages by providing apparatuses (e.g., a system, computer program product and/or other devices) and methods for providing offers to users that the way, the system optimizes where the offers are directed, thus providing users only offers for products that the user may actually be interested in purchasing. These offers may be for products that the user has previously purchased, offers for products that the user has previously accepted offers for, or offers based on the user's demographic. In this way, the user may receive offers for products that the user has purchased in the past, may purchase in the future, or is planning to purchase. Thus, the offers are directed to individuals whom will use the offers to purchase products and not directed to individuals whom will not act on the offer. Therefore, the invention provides a user with offers to purchase products from merchants that the user may have purchased in the past or wants to purchase in the future, thus eliminating offers that are directed to individuals with no desire to purchase the product of the offer.

In some embodiments, a user may opt-in to using the optimized offer program. Opting in requires the user to indicate that he/she wants to receive optimized offers from the optimized offer program. The user may opt-in via the Internet, visiting a financial institution, text messaging, voice messaging, accessing an interface, a mobile application, or the like. Once the user has opted in to the optimized offer program the system may provide the user offers based on the user's transaction history, offer acceptance history, or demographic. In other embodiments, the offer may be based on manually inputted data from the user, indicating products the user may wish to purchase. In still other embodiments, the offer may be based on a combination the user's transaction history, previously accepted offers, demographic, and/or manual inputs. In this way, the system may provide a user with an offer to purchase a product that the user may have an interest in purchasing.

An offer that may be provided to the user may be in the form of a discount, rebate, coupon, etc. that may expire within a predetermined amount of time or may be available to the user at any time he/she wishes to make a transaction. In some embodiments, the offers may be for products that the user previously request. In some embodiments, offers may be for specific products. In yet other embodiments, offers may be available for use at specific merchants.

In some embodiments, the offers provided to the user via the optimized offer program may be based on the user's transaction history. Transaction history may be determined base on criteria such as, but not limited to, spending history, including products acquired; amount spent on products; merchants at which products were acquired; amount spent at specific merchant; how recently products were acquired; social aspects of surrounding individuals; how recently a merchant was used to make a purchase/transaction; spending/transaction patterns, such as time of date/week/month/year for making purchases/transactions; offers used to make purchases/transactions; friends and family transaction; social network data; and the like. For example, the social aspects of individuals surrounding the user, such as family, friends, and neighbors, may indicate products that the user may wish to purchase, such as all of the user's neighbors putting on a new roof. The fact that all of the user's neighbors are putting on a new roof may provide an indication that the user may wish to purchase a new roof as well. Spending/transaction patterns may determine that the user typically purchases groceries every Friday, therefore offers for groceries may be provided to the user on Thursday. In yet another example, spending/transaction patterns may predict life events or life stages that the user is going through, such as the user purchasing several products related to having a child. The transaction history data may be determined based on credit, debit, and other demand deposit account purchases/transactions, financial intuitions or the like are in a unique position to have such transaction history data at their disposal. In this regard, many of the embodiments herein disclosed leverage financial institution data, which is uniquely specific to financial institution.

In some embodiments, the offers provided to the user via the optimized offer program may be based on the user's offer acceptance history. The system may store offers that the user has previously used from the optimized offer program. The system may also recognize from merchants, which offers, independent of the optimized offer program the user has used. For example, a merchant may provide information to the financial institution indicating that a user used a promotion that the merchant was running independent of the optimized offer program. Thus, the system may recognize the offer the user used to purchase the product. In this way, the system may provide offers to the user that the system knows the user has used offers for the same or similar products in the past. Therefore, there is probability that the user has interest in the product or the category of that product. For example, if the user has used several offers both from the optimized offer program and independent of the optimized offer program for products at a sporting goods store. When offers are provided to the system from commercial partners, the offers for products at a sporting goods store may be provided to the user, based on the user's prior acceptance and use of offers for products at a sporting goods store.

In some embodiments, the offers provided to the user via the optimized offer program may be based on the user's demographic. The user's demographic provides a statistical characterization of the population in the area of the user's location. Commonly examined demographics include gender, race, age, disabilities, mobility, home ownership, employment status, affiliations, and even location. Trends in demographic provide the system with a demographic profile of the user and thus an indication of offers the user may have interest in. For example, a user with the demographic profile of a single, middle-class, female, age 21-28, with a college education may not be interested in the same offers that a user with a demographic profile of married, upper-class, male, age 64-70, with college education and affiliated with a country club. In another example, the user's neighbors may all purchase products at similar merchants. In this way, the neighborhood that the user lives in and the use's neighbors may provide an indication as to the products the user may purchase. Therefore, the system may recognize the demographic the user may be in and provide offers that may fit within the demographic profile of the user.

In other embodiments, the offers provided to the user via the optimized offer program may be based on the user's watch list of products. Watch list products include favorite products of the user that the user may wish to purchase or will purchase in the future. In some embodiments, watch list products may be provided to the system by the user by an interface. The interface may be provided from a financial institution to the mobile device of the user. The interface may also be provided from a financial institution to the user through online banking means. The user may access the interface in any means he/she would typically access online banking. In this way, the user may provide watch list products at any time they have access to online banking. Watch list products may also be provided by the user by social networks. In this way, the individual may provide a list of products or business he recommends on his social network page.

In some embodiments, the offer provided to the user through the optimized offer program may be based one of the user's transaction history, the user's previously accepted offers, the user's demographic, or the user's watch list of products. In other embodiments, the offer provided to the user through the optimized offer program may be based on a combination the user's transaction history, previously accepted offers, demographic, and/or watch list. In this way, the system may provide a user with an offer to purchase a product that the user may have an interest in purchasing.

The system may then match the user, based on the user's transaction history, previously accepted offers, demographic, and/or watch list with an offer. An offer may be from a commercial partner of the financial institution. The offers may be stored in a searchable directory. Matching an offer to a user based on the user's transaction history, previously accepted offers, demographic, and/or watch list allows the system to provide several offers from commercial partners of the financial institution, to the user, such that the offers may be for products that the user may actually be interested in.

Once a match is determined the system may send one or many offers to the user. In some embodiments, the offers may be sent to the user via a network, to the user's mobile device. In other embodiments, the offer may be sent to the user via text massage, voice message, standard mail, a mobile application, to an email address, to a social network site of the user, and/or the like and not necessarily sent to the user's mobile device. The user may accept the offer for products and subsequently purchase the product of the offer from a commercial partner merchant. In some embodiments, the user may pass the offers on to another individual through social networking, emailing, text messaging, mobile application, etc. such that the other individual may use the offer.

Embodiments of the invention relate to systems, methods, and computer program products for providing offers to a user, comprising: receiving financial transaction data associated with a user; determining, from the financial transaction data, categories of products previously purchased by the user; filtering from a data store of product offers, one or more selected product offers offered for the categories of products previously purchased by the user; and providing the selected product offers to the user associated with the financial transaction data to thereby provide offers to the user for one or more categories of products the user likely has an interest.

In some embodiments, a determination may be made from the financial transaction data as to at least one or more offers previously accepted by the user. The filtering of product offers may then determine one or more selected product offers offered for categories of products based at least in part on offers previously accepted by the user, such that the selected product offers provided to the user are in the same categories as the categories associated with the one or more offers previously accepted by the user.

In some embodiments, a determination may be made from the financial transaction data as to at least one of one or more categories associated with the financial transaction data. The filtering selected product offers may then determine selected merchants that provide products in the same categories as the one or more categories associated with the financial transaction data and providing selected product offers from the selected merchants.

In some embodiments, a determination may be made from the financial transaction data demographic data of the user. The filtering of product offers may then determine one or more selected product offers offered for categories of products is based at least in part on demographic data associated with the user. The demographic data is associated with the user comprises product purchasing information of the user and individuals living in the same geographic location as the user.

In some embodiments, filtering one or more selected product offers comprises determining one or more selected products offered at a merchant the user has previously purchased from. The filtering one or more selected product offers may further comprise determining one or more selected products offered for a brand of product the user has previously purchased.

In some embodiments, determining from a data store of product offers, one or more selected product offers offered for products the user will likely purchase. The determining the products the user will likely purchase is determined by establishing categories of products of interest for the user, the categories of products of interest are based at least in part on prior transactions of the user and prior offers accepted by the user.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a high level process flow illustrating an optimized offer program process, in accordance with one embodiment of the present invention;

FIG. 2 provides an optimized offer program system environment, in accordance with one embodiment of the present invention;

FIG. 3 provides a process map illustrating the determination of offers, in accordance with one embodiment of the present invention;

FIG. 4 provides a Venn diagram illustrating the selection of offers for presentment to a user, in accordance with one embodiment of the present invention;

FIG. 5 provides a Venn diagram illustrating the selection of offers for presentment to a user, in accordance with one embodiment of the present invention;

FIG. 6 provides a process map illustrating a user's selection process, in accordance with one embodiment of the present invention;

FIG. 7 provides an offer interface, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Furthermore, as used herein, the term “product” shall mean any good, service, event, etc. that may be offered by a merchant. In addition, the term “offer” is used herein to denote any form of offer, promotion, rebate, coupon, incentive, and/or the like offered for the purchase, lease, and/or the like of a product. A “transaction” as used herein may refer to a purchase, lease, barter, and/or any other form of transfer of product from a merchant to a user. A “merchant” as used herein may refer to a manufacturer, retailer, service provider, event provider, warehouse, supplier, commercial partner of a financial institution, and/or the like.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that offer payment account systems to users.

Further, the embodiments described herein may refer to use of a transaction or transaction event to trigger determining the transaction history of the user. Unless specifically limited by the context, a “transaction” refers to any communication between the user and the financial institution or other entity monitoring the user's activities. In some embodiments, for example, a transaction may refer to a purchase of goods or services, a return of goods or services, a payment transaction, a credit transaction, or other interaction involving a user's bank account. As further examples, a transaction may occur when an entity associated with the user is alerted. A transaction may occur when a user accesses a building, uses a rewards card, and/or performs an account balance query. A transaction may occur as a user's device establishes a wireless connection, such as a Wi-Fi connection, with a point-of-sale terminal. In some embodiments, a transaction may include one or more of the following: purchasing, renting, selling, and/or leasing goods and/or services (e.g., groceries, stamps, tickets, DVDs, vending machine items, etc.); withdrawing cash; making payments to creditors (e.g., paying monthly bills; paying federal, state, and/or local taxes and/or bills; etc.); sending remittances; transferring balances from one account to another account; loading money onto stored value cards (SVCs) and/or prepaid cards; donating to charities; and/or the like.

In some embodiments, the transaction may refer to an event and/or action or group of actions facilitated or performed by a user's device, such as a user's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the user's perspective, the merchant's perspective or both. In some embodiments, the point-of-transaction device refers only to a user's device, in other embodiments it refers only to a merchant device, and in yet other embodiments, it refers to both a user device and a merchant device interacting to perform a transaction. For example, in one embodiment, the point-of-transaction device refers to the user's mobile device configured to communicate with a merchant's point of sale terminal, whereas in other embodiments, the point-of-transaction device refers to the merchant's point of sale terminal configured to communicate with a user's mobile device, and in yet other embodiments, the point-of-transaction device refers to both the user's mobile device and the merchant's point of sale terminal configured to communicate with each other to carry out a transaction.

In some embodiments, a point-of-transaction device is or includes an interactive computer terminal that is configured to initiate, perform, complete, and/or facilitate one or more transactions. A point-of-transaction device could be or include any device that a user may use to perform a transaction with an entity, such as, but not limited to, an ATM, a loyalty device such as a rewards card, loyalty card or other loyalty device, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, etc.), a mobile device (e.g., a smartphone, cellular phone, personal digital assistant (PDA) device, MP3 device, personal GPS device, etc.), a merchant terminal, a self-service machine (e.g., vending machine, self-checkout machine, etc.), a public and/or business kiosk (e.g., an Internet kiosk, ticketing kiosk, bill pay kiosk, etc.), a gaming device (e.g., Nintendo Wii®, PlayStation Portable®, etc.), and/or various combinations of the foregoing.

In some embodiments, a point-of-transaction device is operated in a public place (e.g., on a street corner, at the doorstep of a private residence, in an open market, at a public rest stop, etc.). In other embodiments, the point-of-transaction device is additionally or alternatively operated in a place of business (e.g., in a retail store, post office, banking center, grocery store, factory floor, etc.). In accordance with some embodiments, the point-of-transaction device is not owned by the user of the point-of-transaction device. Rather, in some embodiments, the point-of-transaction device is owned by a mobile business operator or a point-of-transaction operator (e.g., merchant, vendor, salesperson, etc.). In yet other embodiments, the point-of-transaction device is owned by the financial institution offering the point-of-transaction device providing functionality in accordance with embodiments of the invention described herein.

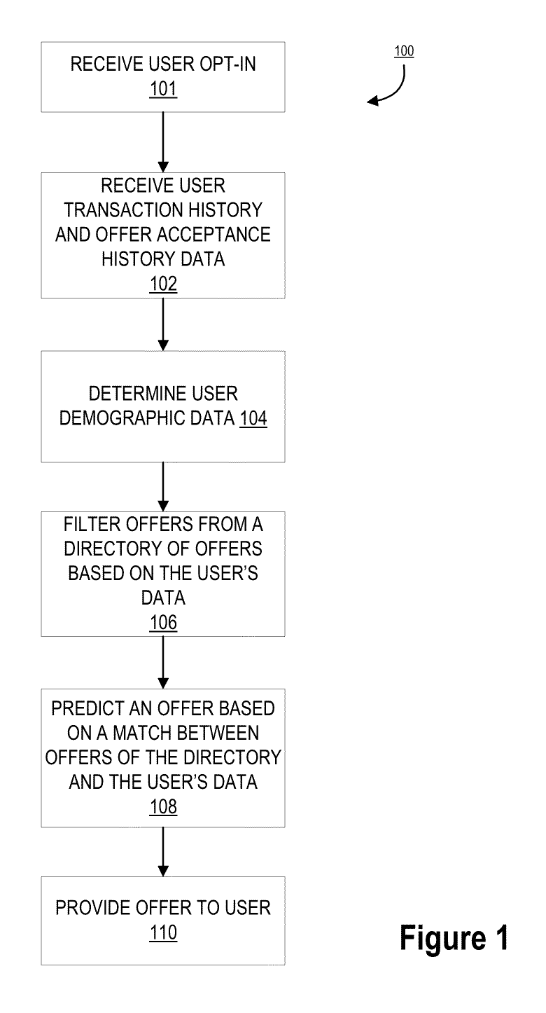

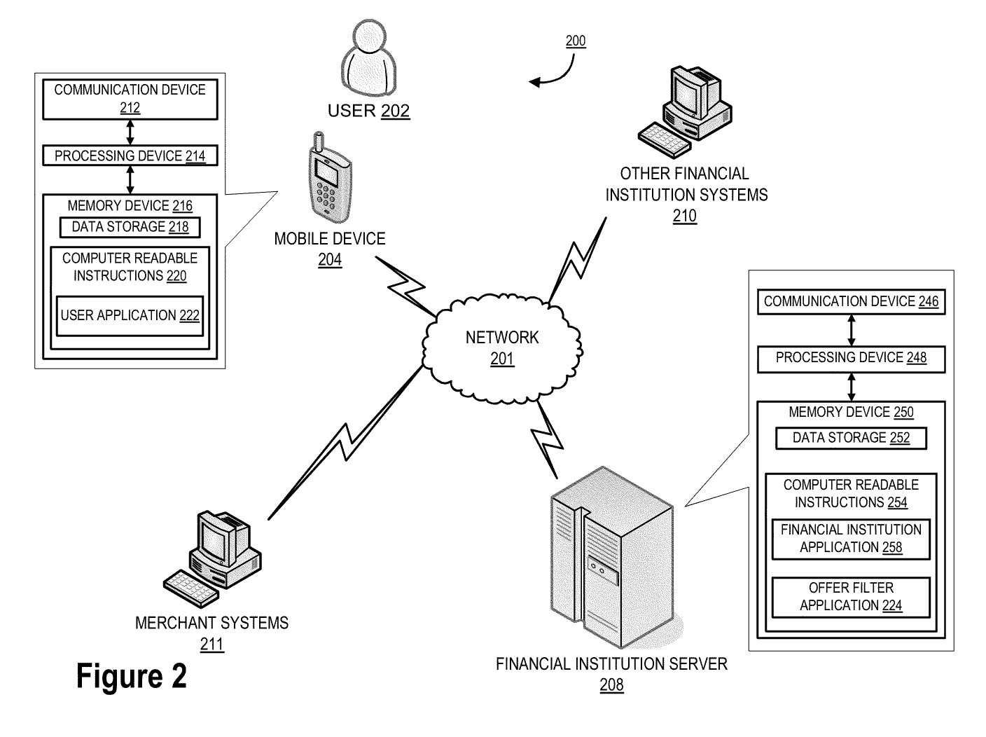

FIG. 1 illustrates a high level process flow for an optimized offer program process 100, which will be discussed in further detail throughout this specification with respect to FIGS. 2 through 7. The first step in the process 100 is to receive an opt-in from a user, as illustrated in block 101. The next step in the process 100 is to receive user transaction history and offer acceptance history data, as illustrated in block 102. The user's transaction history data may be determined based on credit, debit, and other demand deposit account purchases/transactions, financial intuitions or the like are in a unique position to have such transaction history data at their disposal. The user's offer acceptance history may be determined by the system based on the financial institution's unique position to be able to obtain financial regarding the user. The system may determine all offers that the user has used within a time frame. These offers may be any from the optimized offer program or other offers from other programs or from the merchant itself. For example, if a user purchased a product at a merchant using a coupon from a newspaper. The financial institution may determine that the user purchased the product for a merchant using the coupon, by an analysis of the user's transaction history data. Next the system determines the user's demographic data, as illustrated in block 104. Demographic data may be determined by the user's transaction history data, previous offer acceptance, as well as other personal information the financial institution has received from the user. For example, the financial institution may know the age, sex, address, earnings, etc. of a user, based on the user having accounts with the financial institution.

Next, in block 106, offers from commercial partners stored in a directory are filtered based on the user's data, such as the user's transaction history, previous offer acceptances, demographic data, and/or manually inputted data from the user. Once the filter has occurred, the system may predict an offer to present to a user, the offer tailored to the user, such that the user will use or at least be interested in the offer. The offer may be based on a match between offers from a directory of offers to the user's data (including the user's transaction history data, previous offer acceptance, demographic data, and user manual input), in block 108. Once a matched offer is predicted, the offer may be provided to the user, as illustrated in block 110.

FIG. 2 provides an optimized offer program system environment 200, in accordance with one embodiment of the present invention. As illustrated in FIG. 2, the financial institution server 208 is operatively coupled, via a network 201 to the mobile device 204, to other financial institution systems 210, and to merchant systems 211. In this way, the financial institution server 208 can send information to and receive information from the mobile device 204, the other financial institution systems 210, and the merchant systems 211, to match and provide tailored offers to a user 202 in the optimized offer program. FIG. 2 illustrates only one example of an embodiment of an optimized offer program system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network.

In some embodiments, the user 202 is an individual. The individual may be an account holder at the financial institution or not associated with the financial institution. The individual may wish to purchase products using offers that are tailored to the user. In some embodiments, the user 202 may be a merchant or a person, employee, agent, independent contractor, etc. acting on behalf of the merchant to enter into a transaction.

As illustrated in FIG. 2, the financial institution server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the mobile device 204, the merchant systems 211, and the other financial institution computer systems 210. As such, the communication device 246 generally comprises a modem, server, or other device for communicating with other devices on the network 201.

As further illustrated in FIG. 2, the financial institution server 208 comprises computer-readable instructions 254 stored in the memory device 250, which in one embodiment includes the computer-readable instructions 254 of a financial institution application 258. In another embodiment the computer-readable instructions 254 stored in the memory device 250 includes the computer-readable instructions 254 of an offer filter application 224. In some embodiments, the memory device 250 includes data storage 252 for storing data related to the financial institution including but not limited to data created and/or used by the financial institution application 258, the offer filter application 224, or the financial information of users 202. The data storage 252 may also store all offers received from merchant systems 211 such that the financial institution application 258 and the offer filter application 224 may filter and match the offers stored with a user 202, such that the user 202 may have offers tailored to the user 202.

In the embodiment illustrated in FIG. 2 and described throughout much of this specification, the financial institution application 258 allows the user 202 to interact with the system. First, the financial institution application 258 allows a user 202 to opt-in to the optimized offer program, via the user's 202 mobile device 204. In some embodiments, the user 202 may opt-in by the Internet, visiting a financial institution, text messaging, voice messaging, accessing an interface, online banking, via applications, or the like. In some embodiments, the financial institution application 258 allows the user 202 to communicate, via the mobile device 204, to indicate a desire to opt-in to the optimized offer program. In other embodiments, the user 202 may not have to opt-in to the optimized offer program, but instead, may be automatically sent offers.

Next, the financial institution application 258 allows the user 202 to manual input products the user 202 may wish to purchase. Therefore, if an offer is available for a product the user 202 inputs or a product similar thereto, the user 202 may receive that offer. Both opting into the optimized offer program and manually inputting watch list products may be performed by a user 202 using an interface provided to the user's 202 mobile device from the financial institution application 258 via a network 201. In some embodiments, the user 202 may provide products the user 202 may wish to purchase, via a watch list interface, such that the system may provide the user 202 with offers for products the user 202 may wish to purchase. In other embodiments, the user 202 may not provide watch list products, the system may still provided the user 202 offers from the optimized offer program.

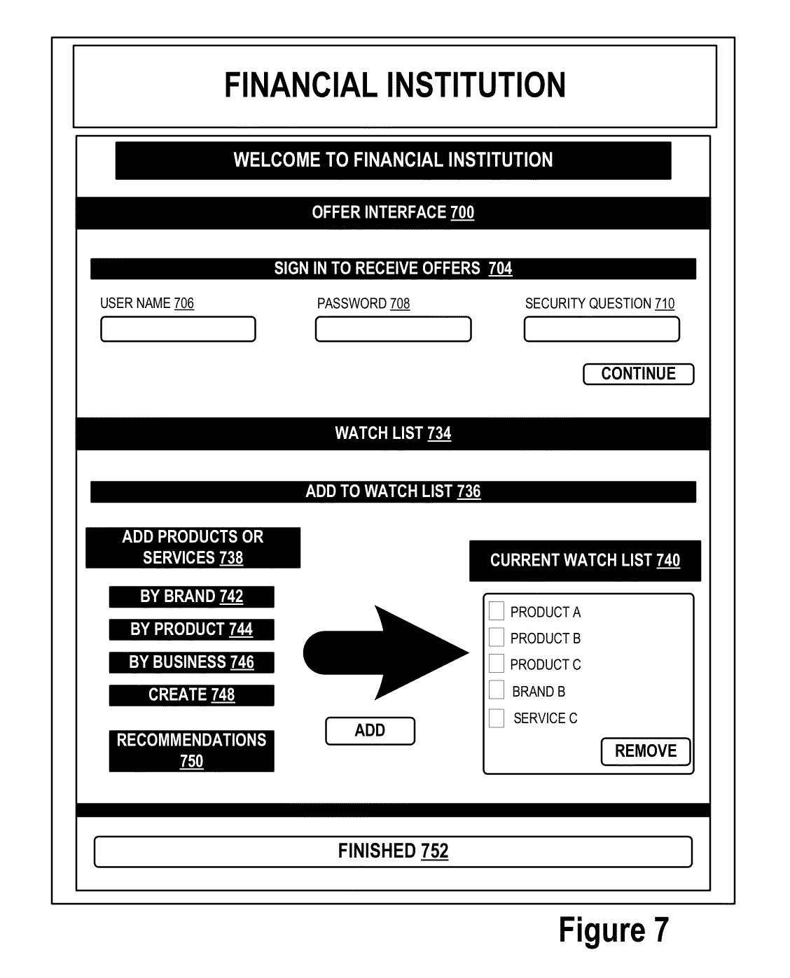

Typically, products the user 202 may wish to purchase may be provided by the user 202 through an offer interface, such as that illustrated in FIG. 7. The financial institution application 258 may receive the watch list products from the user 202 once the user 202 has inputted the products onto the interface. Once the financial institution application 258 receives this data, it may be stored in the memory device 250, such that if a merchant provides an offer for the same or similar product that is on the watch list of the user 202 the financial institution application 258 may provide the user 202 an offer for a product matching a product the user 202 inputted on the watch list. Furthermore, the financial institution application 258 may contact merchants, via the network 201 to a merchant system 211 to enquire as to whether a product on the user's 202 watch list may be eligible for an offer via the optimized offer program. For example, the user 202 may put a television on his/her watch list. At that point, the financial institution application 258 may search the directory in the data storage 252 to determine if there is an offer from a merchant similar to the television the user 202 is requesting. If the television the user 202 puts on his/her watch list has a corresponding offer from a merchant for the optimized offer program, the system will provide the offer to the user 202. In some embodiments, there may be a merchant providing an offer for a similar television to the one the user 202 placed on his/her watch list. In this way, the system may provide the user 202 with an offer for the similar product that has an offer associated with it on the optimized offer program.

The financial institution application 258 may also receive user 202 transaction history data. Transaction history data may be determined base on criteria such as, but not limited to, spending history, including products acquired; amount spent on products; merchants at which products were acquired; amount spent at specific merchant; friends and family transaction; social network data; how recently products were acquired; how recently a merchant was used to make a purchase/transaction; spending/transaction patterns, such as time of date/week/month/year for making purchases/transactions; social aspects of surrounding individuals; offers used to make purchases/transactions; and the like. For example, the social aspects of individuals surrounding the user, such as family, friends, and neighbors, may indicate products that the user may wish to purchase, such as all of the user's neighbors putting on a new roof. The fact that all of the user's neighbors are putting on a new roof may provide an indication that the user may wish to purchase a new roof as well. Spending/transaction patterns may determine that the user typically purchases groceries every Friday, therefore offers for groceries may be provided to the user on Thursday. In yet another example, spending/transaction patterns may predict life events or life stages that the user is going through, such as the user purchasing several products related to having a child. The transaction history data may be determined based on credit, debit, and other demand deposit account purchases/transactions, financial intuitions, or the like are in a unique position to have such transaction history data at their disposal.

The financial institution application 258 may compile the transaction history data to determine frequented merchants of the user 202. For example, the user 202 may have made a transaction several times throughout the last year at a sporting goods store, Store A. The financial institution application 258 may recognize this and determine if an offer is available for the user 202 from Store A. However, the user 202 may have only purchased one item in the last year from a different sporting goods store, Store B. The financial institution application 258 may recognize this and not attempt to find an offer for Store B, knowing that the user 202 has only shopped there one time. However, the financial institution application 258 may also examine the amount of money the user 202 spent at the respective stores. Therefore, if the user 202 went to Store B only one time, but spent several thousand dollars the one time he/she went, the financial institution application 258 may recognize that and attempt to provide the user 202 with an offer for Store B. The financial institution application 258 may also recognize the location of the merchants with respect to the user's 202 home. For example, maybe the reason the user 202 only went to Store B one time last year was because it is several hours away from his/her home. Therefore, if the system decides to provide the user 202 an offer for Store B, the offer would have to be good for an extended period of time, thus allowing the user 202 an opportunity to get back to Store B.

In some embodiments, the financial institution application 258 receives user 202 transaction history data from the financial institution providing the optimized offer program. In some embodiments, the financial institution application 258 receives user 202 transaction history data from other financial institutions, through the other financial institution systems 210. The financial institution application 258 may receive the user 202 transaction history data, compile the data, and determine which merchants the user 202 may frequent. In this way, the financial institution application 258 may provide the frequented merchants, the merchants the user 202 spends the most money, etc. to the offer filter application, such that the offers may be filtered based on the user's 202 transaction history. In this way, the user 202 may receive offers through the optimized offer program for products, brands of products, or merchants that the user 202 has purchased or frequented.

The financial institution application 258 may also receive offer acceptance history data. Offer acceptance history is a history of all the offers previously accepted by the user 202. The financial institution application 258 may store data regarding the previously accepted offers of the user 202 in the memory device 250, such that these offers may be compared to potential offers that may be provided to the user 202. Offer acceptance history comprises offers that the user 202 has previously used from the optimized offer program. For example, the financial institution application 258 may have provided several offers to the user 202 through the optimized offer program in the past. These offers may have been for several merchants, such as Merchant 1, Merchant 2, and Merchant 3. After the user 202 may have received several offers through the optimized offer program from Merchant 1, Merchant 2, and Merchant 3, the financial institution application 258 may recognize that the user 202 has not used an offer from Merchant 3, but has used several offers from Merchant 1. Therefore, the financial institution application 258 may determine to provide the user 202 with more offers from Merchant one and less offers, if any, from Merchant 3. Offer acceptance history further comprises offers the user 202 has accepted independent of the optimized offer program. For example, a merchant may provide information to the financial institution indicating that a user 202 used a coupon to purchase exercise equipment from the merchant. The coupon may have been provided to the user 202 independent of the optimized offer program, such as directly from the merchant, manufacturer, etc.

Offer acceptance history data may be determined by the financial institution application 258 in several ways. In some embodiments, offer acceptance history data may be determined by the financial institution server 208 due to the unique position of the financial institution with respect to receiving transaction requests from the user 202. For example, if the user 202 is attempting to make a purchase using a payment account that is supplied by the financial institution, the financial institution may receive information about the purchase, such that the financial institution may authorize the transaction and apply payment to the appropriate payment account of the user 202. In this way, the financial institution may be able to determine the price of the product and whether any offers or promotions were used to purchase the product. In some embodiments, offer acceptance history data may be determined by receiving information from merchants. In this way, the merchant system 211 may provide the financial institution server 208, via a network 201, indications as to whether a user 202 has purchased products from that merchant using any type of offer, independent of the provider of the offer. In yet other embodiments, offer acceptance history data may be determined by requesting information from merchants. In this way, the financial institution application 258 may request information from merchant systems 211 via the network 201, such that the financial institution application 258 may request which products the merchant is providing offers. The financial institution application 258 may then be able to mine the financial institution data to determine if the user 202 either purchased that product or transacted at the merchant providing the offer. In this way, the financial institution application 258 may determine which merchants and/or merchant offers the user 202 has recently used when purchasing a product. In yet other embodiments, offer acceptance history data may be determined by requesting information from other financial institutions through other financial institution systems 210. Other financial institutions, not providing the optimized offer program, may provide the financial institution application 258 information regarding whether users 202 of the optimized offer program, whom have accounts with other financial institutions, may have purchased products using offers. Furthermore, offer acceptance history data may be determined by receiving information from other financial institutions through other financial institution systems 210. Using these resources the financial institution application 258 may recognize the offers that users 202 of the optimized offer program may have utilized in the past to purchase products, either through the optimized offer program or independent of the optimized offer program.

In this way, the financial institution application 258 may provide offers to the user 202 that the financial institution application 258 may recognized as similar offers to the offers the user 202 has utilized in the past to purchase products. Therefore, there is probability that the user 202 has interest in the product or the category of that product. For example, if the user 202 has used several offers both from the optimized offer program and independent of the optimized offer program for products at a sporting goods store. When offers are provided to the system from merchants, the offers for products at a sporting goods store may be provided to the user 202, based on the user's 202 prior acceptance and use of offers for products at a sporting goods store and likelihood that the user 202 may purchase from that sporting goods store again.

In the embodiment illustrated in FIG. 2 and described throughout much of this specification, the financial institution application 258 may also determine the user's 202 demographic. In some embodiments, the offers provided to the user 202 via the optimized offer program may be based on the user's 202 demographic. The user's 202 demographic provides a statistical characterization of the population in the area of the user's 202 location. Commonly examined demographics include gender, race, age, disabilities, mobility, home ownership, employment status, and even location. Trends in demographic provide the financial institution application 258 with a demographic profile of the user 202 and thus an indication of offers that the user 202 may have interest in. For example, a user 202 with the demographic profile of a single, middle-class, female, age 21-28, with a college education may not be interested in the same offers that a user with a demographic profile of married, upper-class, male, age 64-70, with college education. A user's demographic is determined from information received regarding the user's 202 transaction history, location, merchants frequented, and the like. The user's 202 location may be determined by the financial institution application 258 via global positioning systems (GPS), location information provided to the financial institution application 258 by the user's 202 mobile device 204 and/or the like. Therefore, the financial institution application 258 may recognize the demographic the user 202 may be in and provide offers that may fit within the demographic profile of the user 202. Location of the user could also be determined based on output from accelerometers, gyroscopes, earth magnetic field sensors, air-pressure sensors (altitude), etc.

In the embodiment illustrated in FIG. 2 and described throughout much of this specification, the offer filter application 224 may receive data from the merchant systems 211 relating to offers that the merchant may provide, store the data within the data storage 252, and filter the optimized offer to the user 202. Data received from the merchant systems 211 may include offers for any products or services manufactured, sold, produced, or the like by the merchant that the merchant may wish to include in the optimized offer program. For example, the merchant may manufacture electronic equipment. The merchant may manufacture several models of speakers, CD players, DVD players, televisions, etc. The merchant may select which of these models to provide an offer to a user 202, through the optimized offer program. Furthermore, the merchant may determine the type of offer to provide to the user 202. For example, the merchant may offer a percentage off the price of a product, coupons, by-one-get-one free offers, promotions, etc. The merchant may provide several different offers for one product, several products, or all products the merchant manufactures or sells. In some embodiments, the amount of offers available for a product or amount of discount for a product may be contingent on the number of users 202 the offer is sent to. For example, if the offer is extremely beneficial or a large value, the merchant may not want to provide a lot of users 202 with the offer. The merchant may want to limit the number of offers given to users 202 or limit the value of some offers compared to others. For example, the merchant may want to reward users 202 that frequent the commercial partner merchant, therefore the merchant may elect to provide greater discounts to those users 202 whom have frequented the merchant or are members of the merchant's rewards program, etc. In another example, a merchant may want to attract new customers; therefore the merchant may elect to provide greater discounts to those users 202 whom have not frequented the merchant.

In some embodiments, merchants may also be commercial partners of the financial institution offering the optimized offer program. If this is the case, it is possible that the offers provided may be more beneficial to a user 202 than other offers that may be provided by merchants. This is largely due to the unique position the financial institution is in with respect to the commercial partner. The commercial partner may have commercial banking needs such as mortgages, lines of credit, financial accounts, etc. that may be provided by the financial institution. In exchange for providing these financial services to the commercial partner the commercial partner may provide special offers to the financial institution. In this way, the commercial partner may receive financial services from the financial institution, while the financial institution may be able to receive discounted products from the commercial partner. In some embodiments, the commercial partner may not be associated with the financial institution, but instead, wish to provide offers to users 202 through the optimized offer program.

These discounted products may be passed on to the users 202 of the optimized offer program. Thereafter, the users 202 may receive these offers and frequent the merchants associated with the offers. Thus, the offers provided through the optimized offer program may comprise of these special offers that are exclusively provided to the financial institution from a commercial partner. In this way, the user 202 may receive more beneficial offers through the optimized offer program than through any other offer programs.

The offer filter application 224 may also filter the offers from merchants with respect to the user's 202 transaction history, offer acceptance history, demographic data, or watch list data as determined by the financial institution application 258. The filtered offers are then matched to users 202 that are predicted to use the offer. The financial institution application 258 may then provide the offers to the selected users 202 via the network, to the user's mobile device 204.

The data stored within the offer filter application 224 and the financial institution application 258 provides computer readable instructions 254 to the processing device 248 for the matching of offers with a user 202 based on one or more of the user's transaction history, offer acceptance history, demographic, and/or watch list. The financial institution application 258 stores the matched offers and communicates the offers to a user 202 via a network 201 to the user's 202 mobile device 204.

Matching offers provided by merchants with users 202 such that the offers are ones that the user 202 may be interested in, may require an analysis of the user's 202 transaction history, offer acceptance history, demographic, and/or watch list data. The financial institution application 258 may provided an offer to a user 202 based on one of these factors, all of these factors or a combination of the factors. The financial institution application 258 and the offer filter application 224 use these factors to determine which offers from merchants are most likely to be accepted by the user 202.

In some embodiment, as explained in further detail below, the financial institution application 258, after matching an offer to a user 202 may present an offer to the user 202. In other embodiments, the financial institution application 258 may present several offers to the user 202. In yet other embodiments, the financial institution application 258 may not present any offers to the user 202. In some embodiments, the financial institution application 258 may present the offers through the communication device 246 of the financial institution server 208 to the user 202 through a network 201, via the user's mobile device 204.

Furthermore, the financial institution application 258 may comprise an artificial intelligence (AI) or other type of intelligence program provided. In this way, the financial institution application 258 may analyze the user's 202 transaction history, offer acceptance history, demographic, and/or watch list data to make an intelligent, yet predicted offer recommendation to the user 202. A predicted offer recommendation is an offer that the financial institution application 258 determines that is going to be, or is likely going to be accepted and used by the user 202 to purchase a product.

FIG. 2 also illustrates a mobile device 204. The mobile device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the financial institution server 208, the merchant systems 211, and the other financial institution computer systems 210. As such, the communication device 212 generally comprises a modem, server, or other device for communicating with other devices on the network 201.

As further illustrated in FIG. 2, the mobile device 204 comprises computer-readable instructions 220 stored in the memory device 216, which in one embodiment includes the computer-readable instructions 220 of a user application 222. In this way, a user 202 may be able to opt-in to the optimized offer program, create watch lists for the program, receive offers, deny offers, accept offers, make payments for transactions, and/or the like using the user application 222. In some embodiments, the memory device 216 includes data storage 218 for storing data related to the mobile device including but not limited to data created and/or used by the user application 222. A “mobile device” 204 may be any mobile communication device, such as a cellular telecommunications device (i.e., a cell phone or mobile phone), personal digital assistant (PDA), a mobile Internet accessing device, or other mobile device including, but not limited to PDAs, pagers, mobile televisions, gaming devices, laptop computers, cameras, video recorders, audio/video player, radio, GPS devices, any combination of the aforementioned, or the like. Although only a single mobile device 204 is depicted in FIG. 2, the payment account determination system environment 200 may contain numerous mobile devices 204.

The other financial institution systems 210 are operatively coupled to the financial institution server 208, the mobile device 204, and/or the merchant systems 211 through the network 201. The other financial institution systems 210 have systems with devices the same or similar to the devices described for the financial institution server 208 and/or the mobile device 204 (i.e., communication device, processing device, and memory device). Therefore, the other financial institution systems 210 communicate with the financial institution server 208, the merchant systems 211, and/or the mobile device 204 in the same or similar way as previously described with respect to each system. The other financial institution computer systems 210, in some embodiments, are comprised of systems and devices that allow the financial institution server 208 to access account information at the other financial institution and/or allow to access transactions the user 202 has entered into using accounts at the other financial institutions. In this way the financial institution application 258 may receive transaction data for users 202 that may use accounts at other financial institutions. From this data, the financial institution application 258 may determine products the user 202 has purchased in the past and offers the user 202 has used in the past, in order to match the user 202 with an appropriate optimized offer.

The merchant systems 211 are operatively coupled to the financial institution server 208, the mobile device 204, and/or the other financial institution systems 210 through the network 201. The merchant systems 211 have systems with devices the same or similar to the devices described for the financial institution server 208 and/or the mobile device 204 (i.e., communication device, processing device, and memory device). Therefore, the merchant systems 211 communicates with the financial institution server 208, the other financial institution systems 210, and/or the mobile device 204 in the same or similar way as previously described with respect to each system.

The merchant systems 211, in some embodiments, provide the financial institution application 258 data with respect to the offers available from the merchant. This data may include all offers that merchants may wish to provide to users 202 of the optimized offer program. The data may include the offer, limitations on the offer, the product the offer is directed, and the like. The limitations on the offer may be a percentage discount not to exceed, a location limitation, a number of offers provided limitation, a number of products purchased using the offer limitation, etc.

In some embodiments, the merchant systems 211 may provide offer acceptance history of a user 202. The merchant may have data regarding the purchases of users 202 when the users 202 purchased products at the merchant, such as which purchase the user 202 made with an offer. The offer the user 202 has previously used at the merchant may or may not be an offer provided to the user 202 via the optimized offer program. In this way, the merchant systems 211 may provide the financial institution server 208 user 202 offer acceptance history for that merchant.

In some embodiments, the merchant systems 211 may receive requests from the financial institution application 258 to provide users 202 with offers. These requests may come in the form of user 202 watch list data. The financial institution application 258 may request for an offer from the merchant if several user 202 watch lists include the same or similar products to the products of the merchant. The requests may be made from the financial institution application 258 through the network 201 to the merchant systems 211 for the merchant to review and consider providing an offer for a product to a user 202 of the optimized offer program.

It is understood that the servers, systems, and devices described herein illustrate one embodiment of the invention. It is further understood that one or more of the servers, systems, and devices can be combined in other embodiments and still function in the same or similar way as the embodiments described herein.

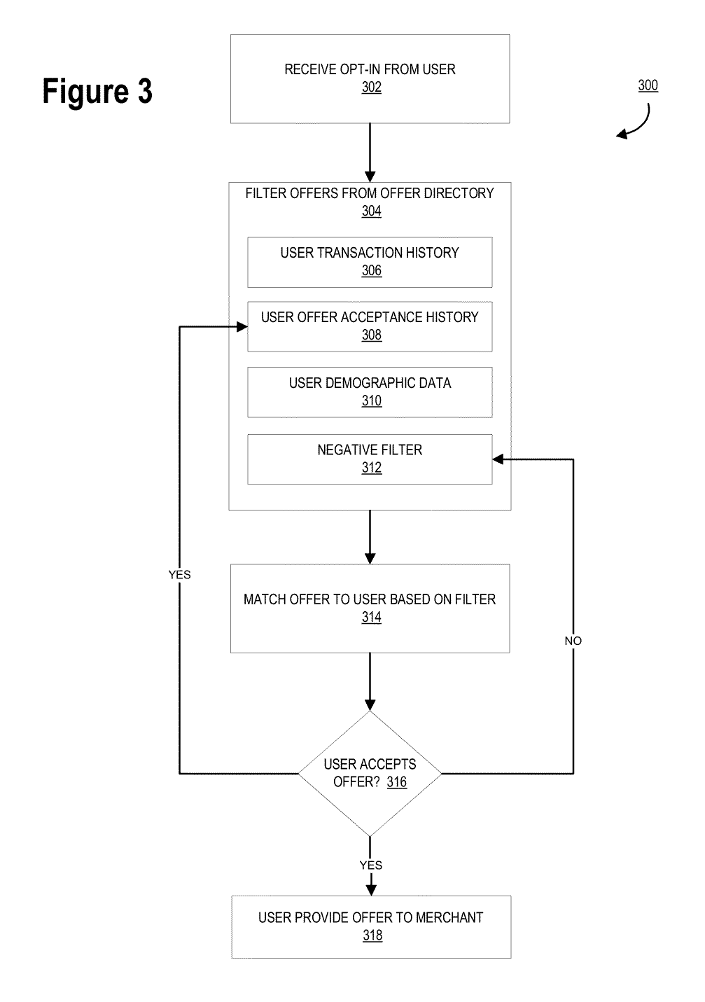

FIG. 3 illustrates a flow chart of the process of determining optimized offers 300, in accordance with one embodiment of the present invention. The flow chart illustrates the flow of data throughout the system. As illustrated in block 302, a user 202 may opt-in to the optimized offer program using his/her mobile device 204. Opting in requires a user 202 to indicate that he/she wants to receive optimized offers from the optimized offer program. The user 202 may opt-in via the Internet, visiting a financial institution, text messaging, voice messaging, accessing an interface, a mobile application, or the like. Once the user 202 has opted in to the optimized offer program the system may provide the user 202 offers based on the user's transaction history, offer acceptance history, or demographic. In other embodiments, the offer may be based on manually inputted data from the user, indicating products the user 202 may wish to purchase. In still other embodiments, the offer may be based on a combination the user's transaction history, previously accepted offers, demographic, and/or manual inputs. In this way, the system may provide a user 202 with an offer to purchase a product that the user may have an interest in purchasing.

Once the user 202 has opted into the optimized offer program, the offers received by the system may be filtered in block 304. These offers may be stored in an offer directory in the system, such that all offers available to any user 202 of the optimized offer program may be filtered to determine the appropriate offers for a specific user 202. The offers are filtered by the specific user's 202 transaction history 306, offer acceptance history 308, demographic 310, and a negative filter 312.

In some embodiments, the offers provided to the user 202 via the optimized offer program may be based on the user's transaction history 306. User transaction history 306 may be determined base on criteria such as, but not limited to, spending history, including products acquired; amount spent on products; merchants at which products were acquired; amount spent at specific merchant; how recently products were acquired; social aspects of individuals surrounding the user 202; how recently a merchant was used to make a purchase/transaction; friends and family transaction; social network data; spending/transaction patterns, such as time of date/week/month/year for making purchases/transactions; offers used to make purchases/transactions; and the like. For example, the social aspects of individuals surrounding the user, such as family, friends, and neighbors, may indicate products that the user may wish to purchase, such as all of the user's neighbors putting on a new roof. The fact that all of the user's neighbors are putting on a new roof may provide an indication that the user may wish to purchase a new roof as well. Spending/transaction patterns may determine that the user typically purchases groceries every Friday, therefore offers for groceries may be provided to the user on Thursday. In yet another example, spending/transaction patterns may predict life events or life stages that the user is going through, such as the user purchasing several products related to having a child. User transaction history 306 may be determined based on credit, debit, and other demand deposit account purchases/transactions, that may be received by the system based on the purchase information received by the financial institution Offers from the offer directory may be filtered based on user transaction history 306, such that if the user 202 has purchased the product, purchased products of the same category, purchased similar products, etc. the system may recognize this and filter out products that are not found in the user transaction history 306. In this way, the user 202 may receive offers for products that are the same, similar to, or of the same category of products that the user 202 has purchased in the past.

In some embodiments, the offers provided to the user 202 via the optimized offer program may be based on the user's offer acceptance history 308. The system may store offers that the user has previously used. The offers may be from the optimized offer program or any offers independent of the optimized offer program. For example, a merchant may provide information to the financial institution indicating that a user 202 used a promotion that the merchant was running independent of the optimized offer program. Thus, the system may recognize any offer the user 202 may have used to purchase a product. Offers from the offer directory may be filtered based on user offer acceptance history 308, such that if the user 202 has accepted and/or used an offer to purchased a product the system may recognize this and filter out products that are not found in the user offer acceptance history 308. In this way, the user 202 may receive offers for products that are the same, similar to, or of the same category of products that the user 202 has accepted an offer for in the past.

In some embodiments, the offers provided to the user 202 via the optimized offer program may be based on the user's demographic data 310. The user's demographic data 310 provides a statistical characterization of the population in the area of the user's 202 location. Commonly examined demographics include gender, race, age, disabilities, mobility, home ownership, employment status, affiliations, and even location. Trends in demographic provide the system with a demographic profile of the user 202 and thus an indication of offers the user 202 may have interest in. For example, a user 202 with the demographic profile of a single, middle-class, female, age 21-28, with a college education may not be interested in the same offers that a user 202 with a demographic profile of married, upper-class, male, age 64-70, with college education and a membership to a country club. Offers from the offer directory may be filtered based on user demographic data 310, such that if the user's 202 demographic matches offers from the offer directory the system may recognize this and filter out offers that are not associated with the user's 202 demographic. In this way, the user 202 may receive offers for products that are the same, similar to, or of the same category of products that match the user's 202 demographic.

In yet other embodiments, offers provided to the user 202 via the optimized offer program may be based on the user's watch list of products. Watch list products include favorite products of the user that the user may wish to purchase or will purchase in the future. In some embodiments, watch list products may be provided to the system by the user by an interface. The interface may be provided from a financial institution to the mobile device of the user. The interface may also be provided from a financial institution to the user through online banking means. The user may access the interface in any means he/she would typically access online banking. In this way, the user may provide watch list products at any time they have access to online banking. Watch list products may also be provided by the user by social networks. In this way, the individual may provide a list of products or business he recommends on his social network page.

The system may also include a negative filter 312 that may filter offers to provide to a user 202. The negative filter 312 may recognize offers the user 202 has received in the past and has turned down. These offers may be from the optimized offer program, the merchant, or any other offer providing source. In this way, the system may recognize the offers the user 202 has declined in the past and subsequently ensure that the offers provided to the user 202 via the optimized offer program are not for the same or similar products as previously declined offers.

As illustrated in block 314, once the offers have been filtered from the offer directory in block 304, the matched offers are provided to the user. In this way, the offers that match the user 202 based on the filtering of offers in block 304 are provided to the user 202 to use when purchasing a product. In some embodiments, the matched offers may be based off of one of the factors for filtering, such as the user transaction history 306. In some embodiments, the matched offers may be based off of several of the factors for filtering.

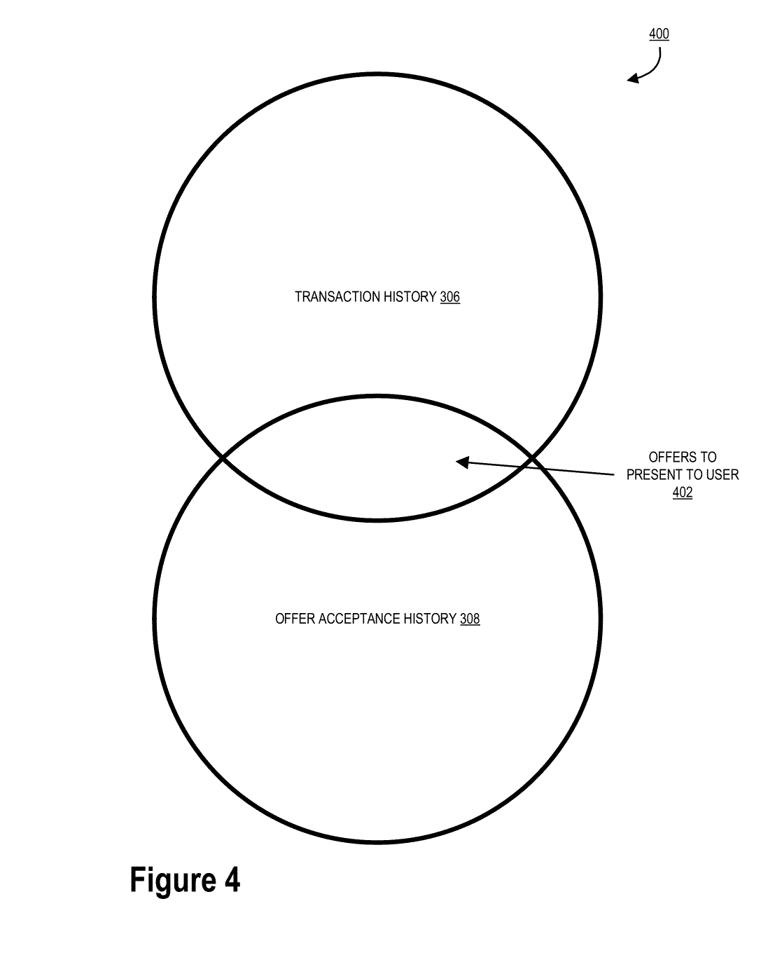

For example, as illustrated in FIG. 4, a Venn diagram indicating the selection of offers for presentment to a user 400, in accordance with one embodiment of the present invention. In the embodiment illustrated in FIG. 4 the system filters offers from an offer directory based on both the user transaction history 306 and the user offer acceptance history 308. Each circle represents the products that the user 202 has purchased in his/her transaction history 306 or that he/she has accepted an offer for in the past 208. Once these circles of products overlay each other, the products that overlap and satisfy both the transaction history 306 and the offer acceptance history 308 of the user are determined. The products in this area are associated with offers from the offer directory that the system may present to the user 202, as illustrated in block 402. In this way, the user 202 may receive offers for similar products, similar categories of products, or for products that the user 202 has both purchased in the past and has accepted an offer for in the past.

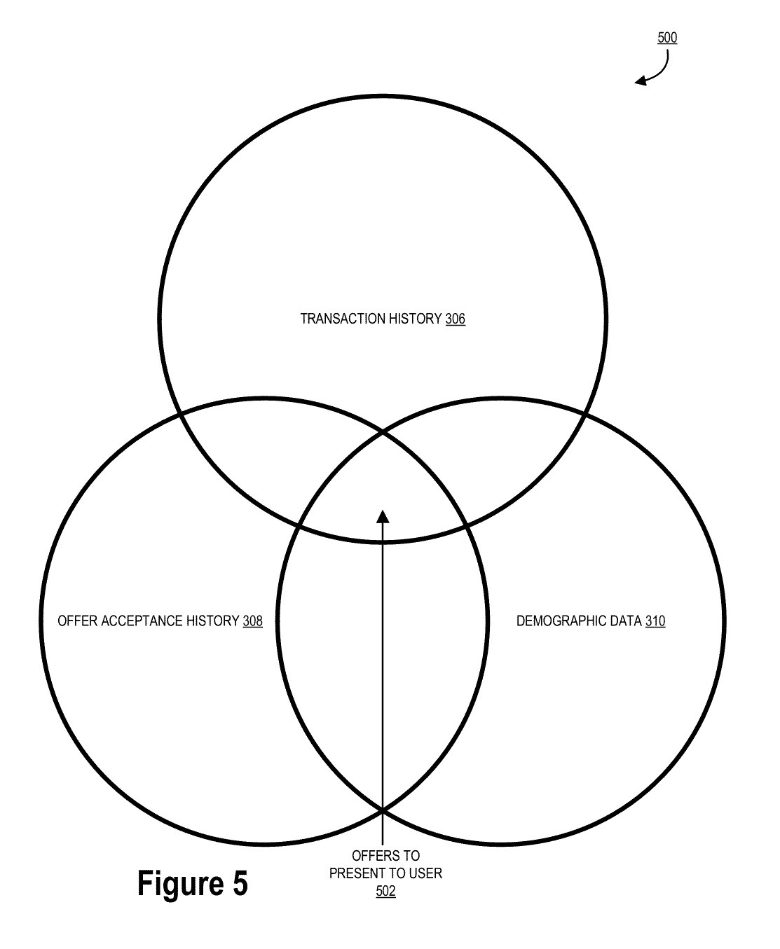

For another example, as illustrated in FIG. 5, a Venn diagram indicating the selection of offers for presentment to a user 500, in accordance with one embodiment of the present invention. In the embodiment illustrated in FIG. 5 the system filters offers from an offer directory based on the user transaction history 306, the user offer acceptance history 308, and demographic data 310. Each circle represents the products that the user 202 has purchased in his/her transaction history 306, that he/she has accepted an offer for in the past 208, or that fits into his/her demographic as a product he/she would purchase. Once these circles of products overlay each other, an area of products are determined to overlay in each of the three transaction history 306, the offer acceptance history 308, and the demographic data 310 may be determined to be matches for the user 202. The products in this area are associated with offers from the offer directory that the system may present to the user 202, as illustrated in block 502. In this way, the user 202 may receive offers for similar products, similar categories of products, or for products that the user 202 has both purchased in the past and has accepted an offer for in the past.

Referring back to FIG. 3, in decision block 316 the user 202 may accept the offer provided to him/her by the optimized offer program. In some embodiments, the matched offers may be based off of one of the factors for filtering. In some embodiments, the matched offers may be based off of several of the factors for filtering, as illustrated in FIG. 4 and FIG. 5.

If the user 202 accepts the offer the in decision block 316, the user is provided an offer to the merchant in block 318. Furthermore, the accepted offer is incorporated into the user offer acceptance history 308, such that the system may recognize the accepted offer as such in the future. If, however, the user 202 does not accept the offer in decision block 316, the not accepted offer is included in the negative filter data 312, such that the system may recognize the product that the user 202 did not accept an offer for.

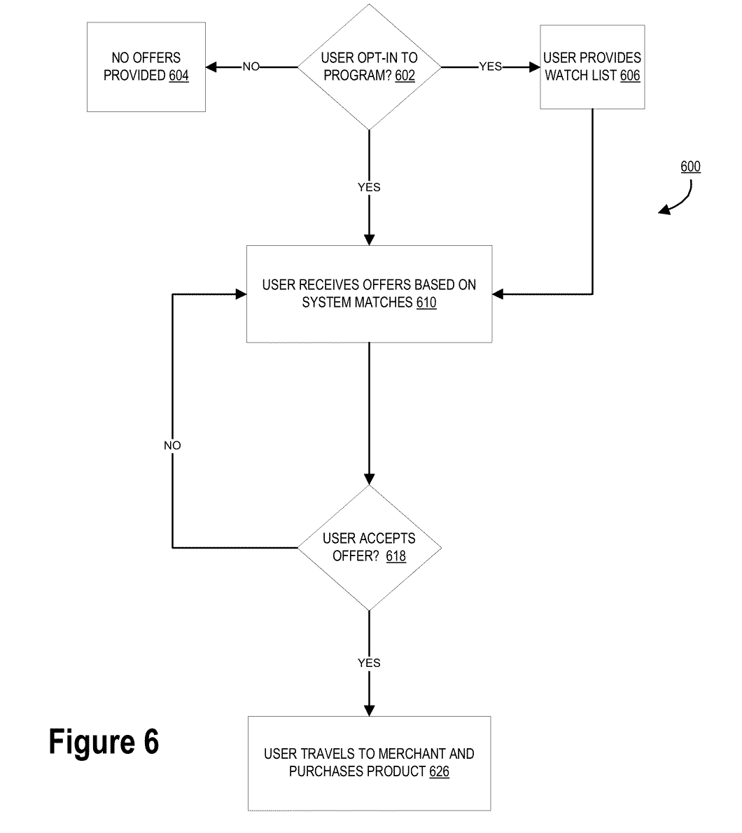

FIG. 6 illustrates a process map of a user's selection process 600, in accordance with one embodiment of the present invention. The user 202 may be able to opt-in to the optimized offer program in block 602. Opting-in to the program may be done by selecting a link provided by the financial institution to download an application on the mobile device or an interface accessible through various avenues such as an online banking application provided by the financial institution or through the other financial institution systems 210, an interface, by social networking, by other selection methods which may include, but are not limited to sending a communication via email, text, voice message, an, application, video message/conference or like means of selecting an opt-in function.

If the user 202 does not choose to opt-in to the program, the user 202 is not provided offers via the optimized offer program as illustrated by block 604. If the user 202 decides to opt-in to the program he/she may provide a watch list, as illustrated in block 606. In some embodiments, the user 202 may not provide products on a watch list. In other embodiments, the user 202 may provide products via a watch list. Watch lists may be created via text messaging, voice messaging, through an interface, an application, social network sites, etc. In this way, the user 202 may conveniently add or remove products from his/her watch list.

FIG. 7 illustrates an offer interface 700 in accordance with some embodiments of the invention. The offer interface 700 provides the user 202 the ability to opt-in to the optimized offer program and/or add products to his/her watch list. As indicated above, opting-in to the program may be done by selecting a link provided by the financial institution to download an application on the mobile device or an interface accessible through various avenues such as an online banking application provided by the financial institution or through the other financial institution systems 210, an interface, by social networking, by other selection methods which may include, but are not limited to sending a communication via email, text, voice message, video message/conference, applications, or like means of selecting an opt-in function. The offer interface 700 provides one means in which a user 202 may opt-in to receive offers via the optimized offer program. The offer interface 700 may be provided from a financial institution to the mobile device 204 of the user 202. The offer interface 700 may also be provided from a financial institution to the user 202 through online banking means. The financial institution server 208 receives a request from a user 202 to opt-in to the optimized offer program. If the user 202 has not already opted in, the financial institution server 208 may prompt the user 202 to create a new sign in to receive offers via the optimized offer program, as illustrated in section 704. As illustrated in the sign in to receive offers section 704, the user 202 creates a user name 706 and password 708 for a new account. In other embodiments, the user 202 may provide a user name 706 and password 708 to log into the user's 202 pre-existing optimized offer program account. In some embodiments, the offer interface 700 requires entering information for security reasons. At this point, the user 202 may enter a user name 706, a password 708, and a reply to a security question 710. If the user name 706, password 708, and the reply to a security question 710 are satisfactory, the interface prompts the user 202 to the next step in the process. For example, if the user name 706 is being used by a current user, the new user will be prompted to create a different user name 706. The user 202 may provide products that the user 202 may wish to purchase, will purchase, or is interested in purchasing via the offer interface 700 in the form of watch lists in the watch list section 734. A directory associated with the system may store data regarding the watch list products of the users 202, such that if an offer arises from a merchant for the product, a similar product, or a similar category of products, the offer may be provided to the user 202 via the optimized offer program.

The watch list section 734 of the offer interface 700 may provide an add to watch list section 736 for adding products or business to the watch list and subsequently viewing products currently on the user's 202 watch list. In the add products or services section 738, the user 202 may select the products or services in which he/she may wish to add to the watch list for the optimized offer program. The user 202 may add products or services by brand 742 which will allow a user 202 to the brand of a business or product to his/her watch list. The user 202 may add products or services by product 744. For example, a user 202 may provide a watch list product by inputting a product, such as a computer. The user 202 may add products or services by business 746. For example, a user 202 may be looking for a specific type of store, such as a dry cleaner. The user 202 may add dry cleaners to his/her watch list, such that the system may indicate dry cleaners with offers that may be provided to the user 202 via the optimized offer program. The user 202 may add products or services to his/her watch list by creating a new search under the create section 748. In this way, the user 202 may provide new or more refined search criteria to add products or services to his/her watch list. The user 202 may also select from a list of recommendations 750. In some embodiments, the recommendations list combines products that the user 202 typically purchases with products that are reviewed for quality. Products the user 202 typically purchases are determined by the financial institution server 208 via an analysis of the transaction history of the user 202. In this way, the user 202 may add to his/her watch list products that he/she may not have purchased yet, but may be interested in purchasing based on the recommendations. In some embodiments, the recommendation list may be provided from the financial institution and data the financial institution acquires. Once the user 202 has selected the product or business by brand 742, by product 744, by business 746, by creating a search 748, or by a recommendation 750 the user 202 may add the product, service, or business to his/her current watch list 740, by selecting the add button.

Once the user 202 has completed adding his favorites he/she may view his/her current watch list that has been compiled, in section 740. The watch list has a compilation of all the products, services, or business that the user 202 has added. The products, services, or business may have been added during a previous log-in session or during the current log-in session. If the user 202 wishes, he/she may remove a product from the current watch list 740 if it is no longer a product the user 202 may wish to purchase. Once the user 202 has completed adding or removing products, services, or business from his/her current watch list 740, to save data added or removed the user 202 may select the finish button 752.

Using the offer interface 700 or other means the user 202 may provide watch list products, services, or business to the optimized offer program at any time convenient to the user 202. In this way, the user 202 may provide products, services, or business to the watch list at any time they have access to online banking or an application on the mobile device 204 of the user 202. Products, services, or business may also be provided to watch lists by the user 202 by social networks. In this way, the individual may provide a list of products, services, or business he/she recommends on his social network page.

Once the user 202 has opted-in to the optimized offer program in decision block 602 and, in some embodiments, has provided a watch list as illustrated in block 606, the user 202 may start to receive offers based on matches, as illustrated in block 610 of FIG. 6. As described in further detail above, the matching of offers is based on several factors that filter offers to be selected by the user 202 including, but not limited to the user's transaction history, the user's offer acceptance history, the user's demographic data, and/or a negative filter.

With the matches between the directory and user 202, based on the filtering of offers using the factors listed above. The user 202 may receive offers for products via the optimized offer program at the user's 202 mobile device 206. The offers provided may be for products that the system determined that the user 202 may purchase, will purchase, or plans to purchase based on factors such as the user's transaction history, the user's offer acceptance history, the user's demographic, and/or the user's watch list. Offers may be in the form of familiar merchant offers, familiar product offers, similar products, competing merchant offers, and/or competing product offers. These offers may be include, but are not limited to discounts, coupons, etc. that may expire within a predetermined amount of time or may be available to the user 202 at any time he/she wishes to make a transaction. Optimized offers may be discounts that the merchant may provide to other customers or the offers may be discounts, etc. provided specifically to users 202 of the optimized offer program. In some embodiments, the user 202 may be provided with several different offers at one time. For example, a user 202 may be provided a familiar merchant offer, a familiar product offer, a similar product offer, and a competing product offer.

Familiar merchant offers may be offers that may be used at a merchant that the user 202 has previously shopped and purchased products from, as determined by the financial institution server 208 by reviewing the user's transaction history. Familiar product offers may be offers that may be used for products that the user 202 has purchased before, as determined by the financial institution server 208 by reviewing the user's transaction history. Similar product offers may be offers for products similar to those that the user 202 is or has purchased. Similar products may be determined by the system based on the transaction data of the user 202. Competing merchant offers may be offers for use at a competitor merchant. The competitor merchant may be a competitor of the merchant the user 202 is transacting with or a familiar merchant of the user 202. This way the system may provide the user 202 an opportunity to visit a new merchant that provides the user 202 with an offer. Competing product offers may be offers for use to purchase a competing product, other than the products that are located at the merchant the user 202 is currently placing a transaction or other than familiar products of the user 202.

The user 202 may accept or decline the offer or offers provided to him/her via the optimized offer program, as illustrated in decision block 618. If the user 202 does decline the offer, then no offer is provided to the user 202 for purchase of a product. Furthermore, information of a declined offer by the user 202 may be provided back to the negative filter to ensure that the user 202 may not be provided an offer in the future for products that he/she has already declined. If the user 202 accepts the offer in decision block 618 the user 202 may travel to the merchant providing the offer and purchase the product at the offer's discounted price, as illustrated in block 626. The offer may be provided to the user 202 via the user's mobile device 204, standard mail, email, social networking site, and/or the like. Furthermore the user 202 may allow others to use his/her offer by providing the offer to others via social network sites, email, standard mail, and/or the like.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, etc.) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for providing offers to a user, the method comprising:
receiving financial transaction data associated with a user;
determining, from the financial transaction data, categories of products previously purchased by the user;
filtering from a data store of product offers, via a computer device processor, one or more selected product offers offered for the categories of products previously purchased by the user; and
providing the selected product offers to the user associated with the financial transaction data to thereby provide offers to the user for one or more categories of products the user likely has an interest.

2. The method according to claim 1 further comprising:
determining from the financial transaction data at least one or more offers previously accepted by the user; and
wherein said filtering of product offers, one or more selected product offers offered for categories of products is based at least in part on offers previously accepted by the user, such that the selected product offers provided to the user are in the same categories as the categories associated with the one or more offers previously accepted by the user.

3. The method according to claim 1 further comprising:
determining from the financial transaction data at least one of one or more categories associated with the financial transaction data, and
wherein said filtering selected product offers further comprises determining selected merchants that provide products in the same categories as the one or more categories associated with the financial transaction data and providing selected product offers from the selected merchants.

4. The method according to claim 1 further comprising:
determining from the financial transaction data demographic data of the user; and
wherein said filtering of product offers, one or more selected product offers offered for categories of products is based at least in part on demographic data associated with the user.

5. The method according to claim 4, wherein demographic data associated with the user comprises product purchasing information of the user and individuals living in the same geographic location as the user.

6. The method according to claim 1, wherein said filtering one or more selected product offers comprises determining one or more selected products offered at a merchant the user has previously purchased from.

7. The method according to claim 1, wherein said filtering one or more selected product offers comprises determining one or more selected products offered for a brand of product the user has previously purchased.

8. The method according to claim 1 further comprising:
determining from a data store of product offers, one or more selected product offers offered for products the user will likely purchase, wherein determining the products the user will likely purchase is determined by establishing categories of products of interest for the user, the categories of products of interest are based at least in part on:
prior transactions of the user; and
prior offers accepted by the user.

9. A system for providing offers to a user, the system comprising:
a memory device;
a communication device; and
a processing device operatively coupled to the memory device and the communication device, wherein the processing device is configured to execute computer-readable program code to:
receiving financial transaction data associated with a user;
determining, from the financial transaction data, categories of products previously purchased by the user;
filtering from a data store of product offers, one or more selected product offers offered for the categories of products previously purchased by the user; and
providing the selected product offers to the user associated with the financial transaction data to thereby provide offers to the user for one or more categories of products the user likely has an interest.

10. The system according to claim 9 wherein the processing device is further configured to:
determine from the financial transaction data at least one or more offers previously accepted by the user; and
wherein said filtering of product offers, one or more selected product offers offered for categories of products is based at least in part on offers previously accepted by the user, such that the selected product offers provided to the user are in the same categories as the categories associated with the one or more offers previously accepted by the user.

11. The system according to claim 9 wherein the processing device is further configured to:
determine from the financial transaction data at least one of one or more categories associated with the financial transaction data, and
wherein said filtering selected product offers further comprises determining selected merchants that provide products in the same categories as the one or more categories associated with the financial transaction data and providing selected product offers from the selected merchants.

12. The system according to claim 9 wherein the processing device is further configured to:
determining from the financial transaction data demographic data of the user; and
wherein said filtering of product offers, one or more selected product offers offered for categories of products is based at least in part on demographic data associated with the user.

13. The system according to claim 12, wherein demographic data associated with the user comprises product purchasing information of the user and individuals living in the same geographic location as the user.

14. The system according to claim 9, wherein said filtering one or more selected product offers comprises determining one or more selected products offered at a merchant the user has previously purchased from.

15. The system according to claim 9, wherein said filtering one or more selected product offers comprises determining one or more selected products offered for a brand of product the user has previously purchased.

16. The system according to claim 9 wherein the processing device is further configured to:
determine from a data store of product offers, one or more selected product offers offered for products the user will likely purchase, wherein determining the products the user will likely purchase is determined by establishing categories of products of interest for the user, the categories of products of interest are based at least in part on:
prior transactions of the user; and
prior offers accepted by the user.

17. A computer program product for providing offers to a user, the computer program product comprising at least one non-transitory computer-readable medium having computer-readable program code portions embodied therein, the computer-readable program code portions comprising:
an executable portion configured for receiving financial transaction data associated with a user;
an executable portion configured for determining, from the financial transaction data, categories of products previously purchased by the user;
an executable portion configured for filtering from a data store of product offers, one or more selected product offers offered for the categories of products previously purchased by the user; and
an executable portion configured for providing the selected product offers to the user associated with the financial transaction data to thereby provide offers to the user for one or more categories of products the user likely has an interest.

18. The computer program product according to claim 17 further comprising:
an executable portion configured for determining from the financial transaction data at least one or more offers previously accepted by the user; and
wherein said filtering of product offers, one or more selected product offers offered for categories of products is based at least in part on offers previously accepted by the user, such that the selected product offers provided to the user are in the same categories as the categories associated with the one or more offers previously accepted by the user.

19. The computer program product according to claim 17 further comprising:
an executable portion configured for determining from the financial transaction data at least one of one or more categories associated with the financial transaction data, and
wherein said filtering selected product offers further comprises determining selected merchants that provide products in the same categories as the one or more categories associated with the financial transaction data and providing selected product offers from the selected merchants.

20. The computer program product according to claim 17 further comprising:
an executable portion configured for determining from the financial transaction data demographic data of the user; and
wherein said filtering of product offers, one or more selected product offers offered for categories of products is based at least in part on demographic data associated with the user.

21. The computer program product according to claim 20, wherein demographic data associated with the user comprises product purchasing information of the user and individuals living in the same geographic location as the user.

22. The computer program product according to claim 17, wherein said filtering one or more selected product offers comprises determining one or more selected products offered at a merchant the user has previously purchased from.

23. The computer program product according to claim 17, wherein said filtering one or more selected product offers comprises determining one or more selected products offered for a brand of product the user has previously purchased.

24. The computer program product according to claim 17 further comprising:
an executable portion configured for determining from a data store of product offers, one or more selected product offers offered for products the user will likely purchase, wherein determining the products the user will likely purchase is determined by establishing categories of products of interest for the user, the categories of products of interest are based at least in part on:
prior transactions of the user; and
prior offers accepted by the user.
